(19) United States
(12) Patent Application Publication
(10) Pub. No.: US 2025/0146101 A1
(43) Pub. Date: May 8, 2025

(54) SELECTIVE SOLUBILIZATION OF GANGUE FROM NICKEL SULFIDES USING BIOSOLVENTS

(71) Applicant: Allonnia, LLC, Boston, MA (US)

(72) Inventors: Dayal Saran, Boston, MA (US); Coy Zimmermann, Boston, MA (US); Tom Lankiewicz, Boston, MA (US); Michaeline Albright, Boston, MA (US); Kathleen Radloff, Boston, MA (US); Kent Sorenson, Boston, MA (US); Dan Stigers, Boston, MA (US)

(73) Assignee: Allonnia, LLC, Boston, MA (US)

(21) Appl. No.: 18/936,816

(22) Filed: Nov. 4, 2024

Related U.S. Application Data
(60) Provisional application No. 63/701,301, filed on Sep. 30, 2024.
(60) Provisional application No. 63/547,324, filed on Nov. 3, 2023.

(51) Int. Cl. C22B 3/16; C22B 3/00; C22B 3/20

(52) U.S. Cl. CPC C22B 3/165; C22B 23/0415; C22B 3/20

(57) ABSTRACT

A mixture includes a nickel-containing ore and/or concentrate thereof and an extraction composition including a fermentation broth obtained from an Aspergillus species (spp.), Acetobacter spp., Bacillus spp., Propionibacterium spp., Corynebacterium spp., Rhizopus spp., Clostridium spp., Fusobacterium spp., Pseudomonas spp., Bifidobacterium spp., Saccharomyces spp., Enterobacter spp., Escherichia spp., among others. The extraction composition is configured to selectively solubilize one or more components, such as a magnesium component from the nickel-containing ore and/or concentrate thereof. A method for extracting a metal from a nickel-containing ore and/or concentrate includes selectively solubilizing a magnesium component from the nickel-containing ore and/or concentrate thereof into an extraction composition including the fermentation broth. The method can include extracting a magnesium component from a nickel-containing ore and/or concentrate thereof into an extraction composition, separating the nickel-containing ore and/or concentrate thereof from an extracted magnesium component and broth, separating the broth from the extracted magnesium component, and repeating the extracting. The extracted magnesium component has a purity in a range from 10% to 90%.

### CROSS-REFERENCE TO RELATED APPLICATION

This application claims benefit to U.S. Provisional Application No. 63/701,301 filed on Sep. 30, 2024 and to U.S. Provisional Application No. 63/547,324 filed on Nov. 3, 2023, the entire contents of each of these applications are incorporated herein by reference in their entirety.

### BACKGROUND

In the mining industry, there has been a general decline in ore grades over time. Decreasing ore quality requires more efficient operation or additional capital expenditure to meet production targets. This also presents an additional issue as further development of electrification technologies, such as battery economy and urbanization fuels, drives demand for relatively higher-grade ores of nickel, lithium, copper, rare earth metals, among others. Accordingly, there exists a need for methods for more sustainable mining practices to ensure production of high grade ore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a mixture that includes a nickel-containing ore and/or concentrate thereof and an extraction composition. The extraction composition includes a fermentation broth obtained from a natural and/or engineered organic acid-producing microbe. The extraction composition is configured to selectively solubilize one or more components including a magnesium component. The magnesium component includes one or more magnesium minerals, a magnesium salt, or any combination thereof from the nickel-containing ore and/or concentrate thereof.

In another aspect, embodiments herein relate to a method for extracting a metal from a nickel-containing ore and/or concentrate that includes selectively solubilizing a magnesium component including one or more magnesium minerals, a magnesium salt, or any combination thereof from the nickel-containing ore and/or concentrate thereof into an extraction composition comprising a broth obtained from fermentation of a natural and/or engineered organic acid-producing microbe.

In another aspect, embodiments herein relate to a method for extracting a metal from nickel sulfide ore that includes extracting a magnesium component from a nickel-containing ore and/or concentrate thereof into an extraction composition comprising a broth obtained from a natural and/or engineered organic acid-producing microbe culture, separating the nickel-containing ore and/or concentrate thereof from an extracted magnesium component and broth, separating the broth from the extracted magnesium component, and repeating the extracting. The magnesium component includes one or more magnesium minerals, a magnesium salt, or any combination thereof. The extracted magnesium component has a purity in a range from 10% to 90%.

Other aspects and advantages of the claimed subject matter will be apparent from the following description and the appended claims.

### BRIEF DESCRIPTION OF DRAWINGS

FIG. 1 is a method of extracting a metal from a nickel-containing ore and/or a concentrate thereof in accordance with one or more embodiments.

FIG. 2 is a simplified block flow diagram of an extraction process that recycles an extraction composition in accordance with one or more embodiments.

FIG. 3 is a graph showing the percent dissolved element (nickel (Ni), cobalt (Co), magnesium oxide (Mg), and iron (Fe)) as a function of organic acid.

FIG. 4 is a graph showing the concentration of organic acids in Biosolvents 3-5 obtained from an Aspergillus spp. culture.

FIG. 5 is a graph showing the percent dissolved component (nickel (Ni), cobalt (Co), magnesium (Mg), and iron (Fe)) as a function of acidic solvent.

FIG. 6 is a graph showing the percent dissolved component (nickel (Ni), cobalt (Co), magnesium (Mg), and iron (Fe)) as a function of acidic solvent.

FIG. 7 is a graph showing the percent dissolved component (nickel (Ni), cobalt (Co), magnesium (Mg), and iron (Fe)) as a function of acidic solvent.

FIG. 8 is a graph showing the percent dissolved component (nickel (Ni), cobalt (Co), magnesium (Mg), and iron (Fe)) as a function of acidic solvent.

FIG. 9 is a graph showing the percentage removal of Fe, Mg, Ni, and S in an extraction composition in a first extraction process and after recycling.

FIG. 10 is a graph showing the parts per million (ppm) concentration of removal of Fe, Mg, and Ni in an extracted solution, in an organic solution after biphasic solvent extraction of the extracted solution, and the extracted solution (aqueous phase) after biphasic solvent treatment.

FIG. 11 is a graph showing the percent metal recovery versus equilibrium pH for removal of Fe, Mg, and Ni from an extracted solution.

FIG. 12 is a graph showing the percentage removal of Fe, Mg and Ni from Ni concentrates from two different sites using citric acid.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

One or more embodiments of the present disclosure are directed to compositions, systems, and methods for enrichment of ore materials, such as a nickel-containing ore and/or a concentrate thereof. For example, in one or more embodiments described herein, methods for (a) selectively removing one or more components (e.g., gangue and impurities) to improve ore grade, (b) selectively removing gangue or impurities from ore to improve processing, (c) extracting metals of value from gangue are described. In some embodiments, a method may include solubilizing cations from ore materials, such as ore tailings and/or from ore substrates and/or gangue material, to support carbon sequestration. As one of ordinary skill may appreciate, the term “gangue” as used herein refers to the material proximate to or in which ore is found having relatively little value as compared to the ore.

Organic acids, such as citric acid and mixtures of organic acids including citric acid, have been used to solubilize certain atoms from nickel ore materials. Previously, citric acid was often found to solubilize iron atoms and/or non-targeted atoms, such as nickel, which decreases the value of the nickel-containing ore material in further downstream processes. However, advantageously, one or more embodiments of the present disclosure unexpectedly show selective removal of magnesium atoms relative to other atoms including, but not limited to, nickel, iron, and cobalt atoms from nickel ore materials (e.g., a nickel-containing ore and/or concentrate thereof), which significantly improves the value of the nickel ore material in further downstream processes, such as a smelting process.

The composition, system, and/or method of one or more embodiments may be directed to the enrichment or upgrading of nickel ore materials by selectively removing one or more components, including, but not limited to, a magnesium component from a nickel-containing ore and/or a concentrate thereof. One or more embodiments herein may relate to a method for advantageously improving nickel-containing ore material by selectively reducing magnesium content (e.g., in the form of a magnesium mineral, a magnesium salt, magnesium oxide, etc.) from a nickel-containing ore and/or a concentrate thereof. This selectivity may be achieved via solubilization of a magnesium component while keeping most of the metals of value (e.g. Nickel (Ni) and Cobalt (Co)) in the solid ore material. In addition, iron components (e.g., iron atoms) may be solubilized to a lesser extent than the magnesium component, which is an unexpected shift in selectivity as compared to traditional processes.

As used herein, the term “organic acid” may include an individual organic acid and/or mixtures of organic acids that are produced by microbes, or organic acids from other biological sources, or organic acids that are synthetically made, unless the source is specified. The “organic acid” as used throughout this disclosure can include a mixture of an organic acid and the respective conjugate base.

As used herein, the term “inorganic acid” may be an acid that is derived from an inorganic compound. The inorganic acid of one or more embodiments may include a protic acid.

As used herein, the term “gangue” refers to the impurity material that surrounds or is closely mixed with a wanted mineral in an ore deposit. Although termed “impurities” it is understood that value can be obtained from certain elements in the gangue, and that such elements are impurities with respect to the wanted material in the ore deposit.

As used herein, the phrase “total mass loss” refers to the difference between a mass of a material after a certain treatment from a mass of a material before a certain treatment. For example, “total mass loss” may refer to a change in mass in an ore material before and after exposure to an extraction process in accordance with one or more embodiments.

As used herein, the phrase “total volume loss” refers to the difference between a volume of a material after a certain treatment from a volume of a material before a certain treatment. For example, “total volume loss” may refer to a change in volume in an extraction composition (e.g., before an extraction process as compared to an extracted solution that has been separated from solid material obtained after an extraction process) in accordance with one or more embodiments.

As used herein, the terms “load” or “leach” refers to the process of transferring one or more components from a first material to a second material. For example, the process of “loading” or “leaching” may include transferring one or more components from an ore material to an extraction composition in accordance with one or more embodiments.

As used herein, the terms “strip” or “separate” refers to the removal of a first component (e.g., an impurity component, a biobroth, a biosolvent, an organic acid, etc.) from a second component (e.g., a mixture, solution, ore material, etc.).

As used herein, the terms “recycle” or “regenerate” refers to the recovery of a material (e.g., a component of an extraction composition, an extraction composition, or both such that the material may be reused in subsequent processes.

As disclosed herein, one or more embodiments relate to combinations of inorganic acids and organic acids and conjugate bases, and optionally one or more additives, at adjusted pH to selectively (a) remove impurities from ore to improve ore grade, (b) remove impurities from ore to improve processing, and (c) extract metals of value from gangue. These combinations selectively solubilize impurities to a greater extent than previous work and open the possibility of using these technological improvements in mining industry processes.

### Extraction Composition and Mixture

In one aspect, embodiments herein relate to an extraction composition. In another aspect, embodiments herein relate to an extraction mixture including an extraction composition and an ore material. As used herein, the term “ore material” refers to a nickel-containing ore and/or concentrate thereof. The ore material may include nickel concentrate after flotation, nickel ore tailings, waste rock including nickel, among other nickel ore materials. The nickel-containing ore material may include, but is not limited to, a nickel-containing compound selected from the group consisting of nickel sulfide, a lateritic nickel compound, a nickel concentrate after flotation, and combinations thereof. The nickel-containing concentrate of one or more embodiments may include nickel-containing ore tailings, a concentrate derived from nickel-containing ore tailings, a nickel concentrate obtained prior to a flotation process, a nickel concentrate obtained after a flotation process, or any combination thereof. A concentrate of the nickel-containing ore may include nickel-containing ore tailings.

The extraction composition may be configured to selectively extract one or more components (e.g., gangue) from a nickel-containing ore material, such as nickel-containing ore and/or a concentrate thereof. In one or more embodiments, the extraction composition is configured to extract a magnesium component. In some embodiments, the extraction composition is configured to selectively extract a magnesium component with an iron component being solubilized to a lesser extent.

The extraction composition may include an aqueous solution. The aqueous solution includes water. The water may include, but is not limited to, Milli-Q water, distilled water, deionized water, tap water, fresh water from surface or subsurface sources, formation water, natural and synthetic brines, brackish water, natural and synthetic sea water, potable water, non-potable water, process water, other waters, and combinations thereof, that are suitable for use for treating a nickel-containing ore and/or a concentrate thereof. As used herein, “Milli-Q water” is water purified using a Millipore Milli-Q laboratory water system. In one or more embodiments, the basic Milli-Q water meets ASTM Type I standards, having greater than 18.0 MegaOhms·centimeter (MΩ·cm) resistivity at 25EC due to ions, less than 10 parts per billion (ppb) organics, less than 0.03 endotoxin per milliliter (EU/mL) of pyrogens, less than 1 particulate per mL (particulate/mL), less than 10 ppb silica, and less than 1 bacterial colony forming unit per mL (cfu/mL).

In one or more embodiments, the water used may naturally contain contaminants, such as salts, ions, minerals, organics, and combinations thereof, as long as the contaminants do not interfere with extraction of target metal atoms from an ore material. In one or more embodiments, one or more additives may be added to the extraction composition to enhance the selectivity for one or more components, efficiency for removing the one or more components, or combinations thereof.

In one or more embodiments, the aqueous solution includes a fermentation broth (i.e., a “biobroth”) obtained from a natural and/or engineered organic acid-producing microbe fermentation process. The organic acid-producing microbe may produce an organic acid or a mixture of organic acids. The organic acid-producing microbe may produce one or more organic acids and one or more components, such as primary metabolites, secondary metabolites, antibodies, salts, ions, organelles, cellular components, extracellular components, biomolecules (e.g., polysaccharides, proteins, enzymes, amino acids, nucleic acids, lipids, carbohydrates, among others), or any combination thereof. As used herein, the terms “fermentation broth,” “biobroth,” and “biosolvent” refer to a complex mixture of components derived from an organism, such as a broth obtained from a culture of a fungus. The complex mixture can include inorganic and/or organic acids and their respective conjugate bases, ionic liquids, amino acids, cellular components derived from a microbe, extracellular components derived from a microbe, or any combination thereof. For example, the biobroth can include one or more enzymes, such as silicase. The biobroth of one or more embodiments may be obtained from an Aspergillus spp. culture, such as a supernatant, a cell lysate, or combinations thereof. The natural and/or engineered microbe may include, but is not limited to, a microorganism of a genus selected from the group consisting of Aspergillus, Acetobacter, Bacillus, Propionibacterium, Corynebacterium, Rhizopus, Clostridium, Fusobacterium, Pseudomonas, Bifidobacterium, Saccharomyces, Enterobacter, Escherichia (e.g., Escherichia coli), and combinations thereof. The term “natural microbe” may be a naturally occurring microbe. The term “engineered microbe” may be a microbe that has been altered, such as with genetic engineering, for example, to modulate acid or other biobroth component production.

Non-limiting examples of an Aspergillus spp. that may be used to produce a fermentation broth in accordance with one or more embodiments may include one or more selected from the group consisting of Aspergillus niger, Aspergillus awamori, Aspergillus nidulans, Aspergillus fonsecaeus, Aspergillus luchensis, Aspergillus phoenicus, Aspergillus wentii, Aspergillus saitoi, Aspergillus flavus, and combinations thereof.

The fermentation broth may include a cell lysate, a supernatant, or combinations thereof. The fermentation broth may include one or more organic acids. The extraction composition, fermentation broth, or both may include a plurality of organic acids. For example, the extraction composition, the fermentation broth, or both may include two or more, three or more organic acids, four or more organic acids, five or more organic acids, six or more organic acids, eight or more organic acids, or ten or more organic acids, etc. In some embodiments, when the first organic acid includes two or more organic acids, a main organic acid component may be present as compared to a minor organic acid component.

The fermentation broth may include a plurality of organic acids in which a first organic acid is a main component and one or more additional acids are a minor component. In some embodiments, the first organic acid is the only acid present in the fermentation broth such that the one or more organic acids consists essentially of the first organic acids. The one or more organic acids may consist essentially of the one or more additional acids. One or more organic acids present in the fermentation broth, such as the first organic acid, the additional organic acid, or both, may be supplemented with an organic acid derived from a source separate from the microbe that produced the biobroth (e.g., with an organic acid produced and/or isolated from a different microbe). In some embodiments, one or more organic acids of the biobroth can be supplemented with a synthetic organic acid. The first organic acid may be an acid selected from the group consisting of citric acid, oxalic acid, and combinations thereof. In some embodiments, the first organic acid includes oxalic acid as a main component and the minor component includes citric acid. In some embodiments, the first organic acid includes citric acid as a main component and the minor component includes oxalic acid. As a non-limiting example, the first organic acid may be citric acid or oxalic acid.

In one or more embodiments, the first organic acid is present in the fermentation broth at a concentration in a range having a non-zero value to 4 M. The organic acid may include an individual organic acid and/or mixtures of organic acids that are produced by microbes, organic acids from other biological sources, or organic acids that are synthetically made. The “organic acid” as used throughout this disclosure can include a mixture of an organic acid and the respective conjugate base of the organic acid. For example, the concentration of the first organic acid may be in a range having a lower limit of any one of a non-zero value, 1 mM (micromolar), 10 mM, 100 mM, 0.001M (Molar), 0.005M, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, 0.9 M, 1 M, 1.5 M, 2M, 2.5 M, 3M, 3.5 M, and 3.9 M and an upper limit of any one of 100 mM, 0.001M, 0.005M, 0.010 M, 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, 1.2 M, 1.5 M, 2 M, 2.5 M, 3 M, 3.5 M, 3.9 M, 3.95 M, and 4 M, where any lower limit can be paired with any mathematically compatible upper limit. As a non-limiting example, the concentration of the first organic acid may be present in a biobroth at a concentration in a range from a non-zero value to 1.5 M.

The minor component of the fermentation broth may include an additional organic acid may include one or more organic acids, two or more organic acids, or a plurality of organic acids. In some embodiments, when the additional organic acid includes two or more organic acids, a main organic acid component may be present as compared to a minor organic acid component. The minor component of the fermentation broth may include an additional organic acid selected from the group consisting of gluconic acid, oxalic acid, formic acid, lactic acid, acetic acid, citric acid, malic acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof.

In one or more embodiments, when the first organic acid is, or includes as a main component, gluconic acid, the additional organic acid comprises an acid selected from the group consisting of oxalic acid, lactic acid, acetic acid, malic acid, gallic acid, aspartic acid, succinic acid, oleic acid, tannic acid, palmitic acid, and combinations thereof. In one or more embodiments, when the first organic acid is, or includes as the main component, oxalic acid, the additional organic acid comprises an acid selected from the group consisting of gluconic acid, oxalic acid, lactic acid, acetic acid, citric acid, gallic acid, aspartic acid, succinic acid, oleic acid, tannic acid, palmitic acid, and combinations thereof. The minor component may have a total concentration of additional organic acid in the fermentation broth in a concentration in a range between 0 M to 1.5 M. For example, the concentration of the first organic acid may be in a range having a lower limit of any one of 0 M, a non-zero value, 1 mM, 10 mM, 100 mM, 0.001M, 0.005M, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, and 0.9 M and an upper limit of any one of 100 mM, 0.001M, 0.005M, 0.010 M, 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, 1.2 M, and 1.5 M, where any lower limit can be paired with any mathematically compatible upper limit.

In some embodiments, a concentration ratio of the main component to the minor component in the fermentation broth is in a range from 1:0 to 1:less than or equal to (≤) 1. In one or more embodiments, the concentration ratio of the first organic acid to the additional organic acid is in a range having a lower limit of any one of 1:0, 1:0.05, 1:0.1, 1:0.2, 1:0.3, 1:0.4, 1:0.5, and 1:0.75, and an upper limit of any one of 1:0.1, 1:0.2, 1:0.3, 1:0.4, 1:0.5, 1:0.6, 1:0.7, 1:0.75, 1:0.8, 1:0.85, 1:0.9, 1:0.95, 1:0.99, and 1:1, where any lower limit can be paired with any mathematically compatible upper limit.

In one or more embodiments, the fermentation broth or the extraction composition includes an inorganic acid. In some embodiments, the inorganic acid is added to the extraction composition. The inorganic acid may include an acid selected from the group consisting of sulfuric acid, hydrochloric acid, nitric acid, phosphoric acid, and combinations thereof. The inorganic acid may be included in the aqueous fluid in an amount in a range from 0 M or a non-zero concentration to 1.5 M. For example, the concentration of the inorganic acid may be in a range having a lower limit of any one of 0 M, a non-zero value, 1 mM, 10 mM, 100 mM, 0.001M, 0.005 M, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, and 0.9 M and an upper limit of any one of 100 mM, 0.001M, 0.005 M, 0.010 M, 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, 1.2 M, and 1.5 M, where any lower limit can be paired with any mathematically compatible upper limit.

The extraction composition of one or more embodiments has a pH in a range from 0.09 to 4.2. In some embodiments, the pH of the extraction composition is in a range having a lower limit of any one of 0.09, 0.10, 0.2, 0.25, 0.5, 0.75, 1, 1.2, 1.5, 1.7, 1.9, 2.0, 2.2, 2.5, 2.7, 2.9, 3.0, 3.2, 3.5, and 3.7 and an upper limit of any one of 1, 1.2, 1.5, 1.7, 1.9, 2.0, 2.2, 2.5, 2.7, 2.9, 3.0, 3.2, 3.5, 3.7, 3.9, 4.0, and 4.2, where any lower limit can be paired with any mathematically compatible upper limit.

### Method for Extracting One or More Components From a Nickel-Containing Ore Material

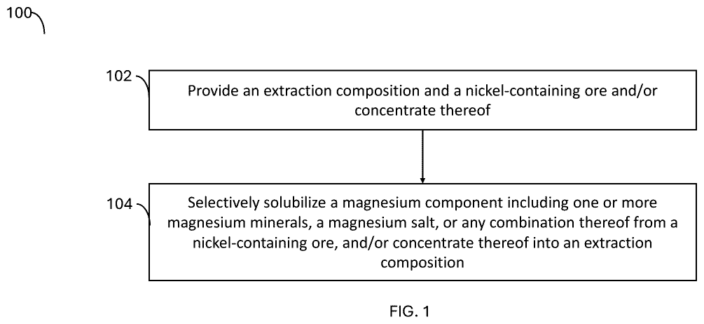

In another aspect, embodiments herein relate to a method for extracting a metal from an ore material, such as a nickel-containing ore and/or a concentrate thereof. A non-limiting method may be as shown in FIG. 1 (e.g., method 100). In some embodiments, method 100 may include block 102 such that an extraction composition and an ore material is provided as shown in FIG. 1. As shown in block 104, method 100 may include selectively solubilizing a magnesium component including one or more magnesium minerals, a magnesium salt, or any combination thereof from a nickel-containing ore and/or concentrate thereof into an extraction composition.

The method may include preparing the extraction composition. The extraction composition may be prepared by obtaining the fermentation broth. The fermentation broth may be obtained by fermenting a natural and/or engineered microbe selected from the group consisting of Aspergillus spp., Acetobacter spp., Bacillus spp., Propionibacterium spp., Corynebacterium spp., Rhizopus spp., Clostridium spp., Fusobacterium spp., Pseudomonas spp., Bifidobacterium spp., Saccharomyces spp., Enterobacter spp., Escherichia spp., among others, and combinations thereof. The process of fermentation may be any process known to those skilled in the art of fermenting a natural and or engineered microbe. As a non-limiting example, the fermentation process may include submerged fermentation, surface fermentation, solid-state fermentation, among other fermentation processes.

The method may include forming the mixture including an extraction composition and an ore material. The extraction composition and the ore material may be as previously described. An extraction composition, an ore material, or both may be introduced (or added) to an extraction unit of an extraction zone, such as an agitated leaching tank of an extraction system. In some embodiments, the extraction zone is a laboratory extraction unit that is a container capable of being manually agitated or stirred for the extraction process. The extraction unit may be a container capable of being automatically agitated or stirred for the extraction process, such as with a control system in electrical connection with the extraction unit. In some embodiments, the method includes providing an extraction system capable of performing one or more leaching processes. The extraction system may include one or more flow lines, valves, pumps, storage tanks, an extraction zone including an extraction unit (e.g., one or more agitated leaching tanks), among one or more additional units known to those skilled in the art for mineral leaching. One or more components of the extraction system may be an add-on component capable of being incorporated to one or more industrial mining processes.

In some embodiments, the extraction zone includes a plurality of leaching tanks positioned in parallel or in series. In one or more embodiments, one or more leaching tanks of the plurality of leaching tanks are in fluid communication with a subsequent leaching tank of the plurality of leaching tanks. In some embodiments, plurality of leaching tanks are positioned in a cross-or counter-current design, in locked cycle leaching, or combinations thereof.

The ore material may be added to the extraction zone in an amount in a range from 5 to 55 wt % based on the total weight of the extraction mixture. The ore material may be added to the extraction unit in an amount in a range having a lower limit of any one of 5 wt %, 7.5 wt %, 8 wt %, 10 wt %, 15 wt %, 20 wt %, 25 wt %, 30 wt %, 40 wt %, 45 wt %, 48 wt %, and 50 wt % and an upper limit of any one of 15 wt %, 20 wt %, 25 wt %, 30 wt %, 40 wt %, 45 wt %, 48 wt %, 50 wt %, 51 wt %, 52 wt %, 53 wt %, 54 wt %, and 55 wt %, where any lower limit can be paired with any mathematically compatible upper limit.

The extraction composition may be added to the extraction unit in an amount in a range from 45 to 95 wt % based on the total weight of the extraction mixture. The extraction composition may be added to the extraction unit in an amount in a range having a lower limit of any one of 45 wt %, 47.5 wt %, 48 wt %, 50 wt %, 55 wt %, 60 wt %, 65 wt %, 70 wt %, 70 wt %, 75 wt %, 78 wt %, and 80 wt % and an upper limit of any one of 55 wt %, 60 wt %, 65 wt %, 70 wt %, 75 wt %, 80 wt %, 85 wt %, 88 wt %, 90 wt %, 91 wt %, 92 wt %, 93 wt %, 94 wt %, and 95 wt %, where any lower limit can be paired with any mathematically compatible upper limit.

The mixture of the extraction composition and the ore material may be agitated in the extraction zone. The mixture may be heated while agitating to promote the selective removal of one or more components from the ore material. Agitating the extraction mixture in the extraction zone may form an extracted solution (or a “liquid mixture”) including the organic acid, the magnesium component, and, optionally, one or more additional components extracted from the nickel-containing ore and/or concentrate thereof. The extraction mixture may be agitated in the extraction unit for a period of time in a range having a lower limit of any one of 1 hour (h), 2 h, 3, h, 4 h, 5 h, 6 h, 8 h, 10 h, 12 h, 14 h, 16 h, 18 h, and 20 h, and an upper limit of any one of 4 h, 5 h, 6 h, 7 h, 8 h, 10 h, 12 h, 14 h, 16 h, 18 h, 20 h, 22 h, 24 h, and 26 h, where any lower limit can be paired with mathematically compatible upper limit. The mixture may be heated (e.g., in the extraction unit) at a temperature in a range from 20° C., 25° C., 27° C., 28° C., 29° C., 30° C., 35° C., 40° C., 45° C., 50° C., 60° C., 70° C., 80° C., 90° C., 95° C., and 99° C. and an upper limit of any one of 35° C., 40° C., 45° C., 50° C., 55° C., 60° C., 65° C., 70° C., 75° C., 80° C., 90° C., 95° C., 99° C., and 100° C., where any lower limit can be paired with any mathematically compatible upper limit. In a non-limiting example, the method may include adjusting a temperature of the extraction zone to a temperature in a range from 20 to 100° C. and performing the extraction zone for a period of time in a range from 1 to 24 hours.

During the agitating step, one or more components may be selectively transferred from the ore material to the extraction composition, thereby forming an liquid mixture (i.e., an extracted solution) including a treated ore material and an extracted solution. The extracted solution of one or more embodiments includes the extraction composition and one or more components removed from the ore material may include one or more selected from a magnesium component, an iron component, among other metallic components (e.g., a nickel and/or a cobalt component). In some embodiments, the one or more components can include an iron component, a nickel component and/or a cobalt component as relatively minor components compared to the magnesium component. In such embodiments, the method of extraction is selective for the magnesium component removal from the ore material. While a quantity of iron may also be solubilized by the extraction composition, advantageously, the extraction composition selectively solubilizes the magnesium such that iron is solubilized to an approximately equal or lesser extent, which may result in a greater Fe:Mg ratio in a treated ore material than conventional extraction compositions. Minimizing and/or reducing iron loss and maintaining and/or improving the Fe:Mg ratio may advantageously retain and/or improve heat transfer in subsequent smelting processes and may improve nickel recovery.

The magnesium component may include magnesium in the form of a magnesium mineral, magnesium oxide, a magnesium salt having a magnesium cation, elemental magnesium, or any other form of magnesium. The iron component may include one or more of an iron mineral, elemental iron, an iron oxide, an iron salt having an iron cation, or any other form of iron. The nickel component may include one or more of elemental nickel, a nickel mineral, a nickel sulfide, a nickel oxide, a nickel salt having a nickel cation, or any other form of nickel. The cobalt component may include one or more of elemental cobalt, a cobalt mineral, a cobalt oxide, a cobalt salt having a cobalt cation, or any other form of cobalt.

The treated ore material may have a reduced magnesium concentration as compared to the untreated ore material, such as a percent of the magnesium component concentration in the untreated ore material. The method of one or more embodiments may reduce the magnesium component in a treated ore material as compared to an untreated ore material by a relative percent. The relative percent of a magnesium component reduced in a treated ore material as compared to an untreated ore material may be in a range having a lower limit of any one of a non-zero value, 1%, 2%, 5%, 10%, 15%, 20%, 25%, 30%, 35%, 40%, 45%, 50%, 55%, 60%, 65%, 70%, 75%, 80%, 85%, and 90%, and an upper limit of any one of 10%, 20%, 25%, 30%, 35%, 40%, 45%, 50%, 55%, 60%, 65%, 70%, 75%, 80%, 85%, 90%, 95%, 98%, 99%, 99.5%, 99.8%, 99.9%, and 100% where any lower limit can be paired with any mathematically compatible upper limit.

The method of one or more embodiments may reduce the magnesium component in an ore material to provide a total mass loss of the magnesium component of about 5 wt % to about 90 wt %. The magnesium component content in an ore material may be reduced by an amount in a range having a lower limit of any one of 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, and 75 wt % and an upper limit of any one of 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, and 90 wt %, where any lower limit can be paired with any mathematically compatible upper limit.

In some embodiments, the treated ore material has a reduced magnesium concentration as compared to the untreated ore material. In one or more embodiments, the treated ore material has a magnesium component content in a range from a 0.01 wt % to 60 wt %. The treated ore material may have a concentration of magnesium in a range having a lower limit of any one of a non-zero value, less than 0.01 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, and 45 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt %, where any lower limit can be paired with any mathematically compatible upper limit. As a non-limiting example, the magnesium component concentration in the treated ore material may be in a range from 1 to 50 wt %. In one or more embodiments, the amount of magnesium in a treated ore material is less than 75 wt %, less than 50 wt %, less than 25 wt %, less than 10 wt %, or less than 0.01 wt % . . .

The treated ore material may have a reduced iron concentration as compared to the untreated ore material, such as a percent of the iron component concentration in the untreated ore material. The method of one or more embodiments may reduce the iron component in an ore material by a relative percent of about 0% to about 85%. The iron component content in an ore material may be reduced by a relative percent in a range having a lower limit of any one of 0%, 5%, 10%, 15%, 20%, 25%, 30%, 35%, 40%, 45%, 50%, 55%, 60%, 65%, 70%, and 75% and an upper limit of any one of 20 wt %, 25%, 30%, 35%, 40%, 45%, 50%, 55%, 60%, 65%, 70%, 75%, 80%, 81%, 82%, 83%, 84%, and 85%, where any lower limit can be paired with any mathematically compatible upper limit.

The method of one or more embodiments may reduce the iron component in an ore material to provide a total mass loss of the magnesium component of about 0 wt % to about 85 wt %. The magnesium component content in an ore material may be reduced by an amount in a range having a lower limit of any one of 0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, and 75 wt % and an upper limit of any one of 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, and 85 wt %, where any lower limit can be paired with any mathematically compatible upper limit.

In one or more embodiments, the untreated ore material has an iron component content in a range from a 0.01 wt % to 85 wt %. The treated ore material may have a concentration of iron in a range having a lower limit of any one of 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, and 85 wt %, where any lower limit can be paired with any mathematically compatible upper limit.

In some embodiments, the treated ore material has a reduced iron concentration as compared to the untreated ore material. In one or more embodiments, the treated ore material has an iron component content in a range from a 0 wt % to 85 wt %. The treated ore material may have a concentration of iron in a range having a lower limit of any one of 0 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, and 85 wt %. where any lower limit can be paired with any mathematically compatible upper limit. As a non-limiting example, the iron component concentration in the treated ore material may be in a range from 0 to 85 wt %. In one or more embodiments, the amount of iron in a treated ore material is less than 85 wt %, less than 80 wt %, less than 75 wt %, less than 50 wt %, less than 25 wt %, less than 10 wt %, or less than 0.01 wt %. In some embodiments, the ore material is upgraded by the selective removal of a magnesium component while retaining metals of value (e.g., iron, nickel, and cobalt) in the solid ore material.

In embodiments where an impurity is found in an ore material in a relatively low amount (e.g., about 0.001 wt % to about 5 wt %), such impurities may be referred to as penalty elements (or “penalty components”), which are considered non-applicable for further processing. These penalty elements may render an ore material unsuitable for further use. Some non-limiting examples of penalty elements can include Mg, Fe, S, among others, such as fluorine (F), silicon (Si), aluminum (Al), phosphorous (P), and arsenic (As). In embodiments in which penalty elements are present in a relatively low amounts in the ore material, the method may advantageously remove one or more impurity components in a relative percentage of 20% or more, 30% more more, 40% or more, 50% or more, 60% or more, 70% or more from the ore material. In embodiments where the ore material is or includes gangue, the method may advantageously increase the value of the ore material via removal of the penalty element while maintaining a relatively large percentage of gangue (e.g., 95%).

The method of one or more embodiments may reduce the one or more impurity components in a treated ore material as compared to an untreated ore material by a relative percent. The relative percent of an impurity component reduced in a treated ore material as compared to an untreated ore material may be in a range having a lower limit of any one of a non-zero value, 1%, 2%, 5%, 10%, 15%, 20%, 25%, 30%, 35%, 40%, 45%, 50%, 55%, 60%, 65%, 70%, 75%, 80%, 85%, and 90%, and an upper limit of any one of 10%, 20%, 25%, 30%, 35%, 40%, 45%, 50%, 55%, 60%, 65%, 70%, 75%, 80%, 85%, 90%, 95%, 98%, 99%, 99.5%, 99.8%, 99.9%, and 100% where any lower limit can be paired with any mathematically compatible upper limit.

The method of one or more embodiments may reduce the one or more impurity components in an ore material to provide a total mass loss of the impurity component of about 1 wt % to about 100 wt %. The reduced one or more components content in an ore material may be reduced by an amount in a range having a lower limit of any one of 1 wt %, 2.5 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, and 75 wt % and an upper limit of any one of 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, and 100 wt %, where any lower limit can be paired with any mathematically compatible upper limit.

In one or more embodiments, the untreated ore material has one or more impurity component content in a range from a 0.001 wt % to 99.999 wt %. The treated ore material may have a concentration of one or more impurity components in a range having a lower limit of any one of 0.001 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 92.5 wt %, 95 wt %, 97.5 wt %, 99 wt %, 99.5 wt %, 99.9 wt %, 99.99 wt %, and 99.999 wt %, where any lower limit can be paired with any mathematically compatible upper limit.

In some embodiments, the treated ore material has a reduced one or more impurity component content as compared to the untreated ore material. In one or more embodiments, the treated ore material has a reduced impurity component content in a range from a 0 wt % to 99.99 wt %. The treated ore material may have a concentration of one or more impurities in a range having a lower limit of any one of 0 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 92.5 wt %, 95 wt %, 96 wt %, 97 wt %, 98 wt %, 99 wt %, 99.95 wt %, and 99.99 wt %, where any lower limit can be paired with any mathematically compatible upper limit. As a non-limiting example, the reduced one or more impurity component concentration in the treated ore material may be in a range from 0 to 95 wt %. In one or more embodiments, the amount of impurity components in a treated ore material is less than 98 wt %, less than 95 wt %, less than 90 wt %, 85 wt %, less than 80 wt %, less than 75 wt %, less than 50 wt %, less than 25 wt %, or less than 10 wt %. In some embodiments, the ore material is upgraded by the selective removal of one or more of Mg, Fe, S, among other possible penalty elements while retaining metals of value (e.g., Fe, Co, and/or Ni) in the solid ore material.

A method of one or more embodiments may include separating a treated ore material from the extracted solution to collect the treated ore and the extracted solution. The treated ore material may be in the form of a solid such that the separation of the treated ore material from the extracted solution can be performed by a method for separating solids from liquids known to those skilled in the art. In some embodiments, the separation includes decanting, filtration, nanofiltration, membrane filtration, osmotic separation (e.g., via reverse osmosis), gravity filtration, centrifugation, among others known to those skilled in the art. The separated treated ore material may be washed and dried. In some embodiments, the separated treated ore is transferred for further processing, including, but not limited to, smelting.

The separation of the magnesium component, and if present, one or more additional metallic components (e.g., Fe, Co, Ni, etc.) from the extracted solution may be performed such that the extraction composition is regenerated. The extracted solution may be fed to a processing unit to regenerate the extraction composition. In some embodiments, separating the magnesium component from the extracted solution includes extracting the magnesium component from the extracted solution with one or more water treatment techniques. The extraction of the magnesium component from the extracted solution may include performing one or more water treatment techniques selected from the group consisting of centrifugation, feeding the extracted solution through an ion exchange system, extracting the magnesium component via solvent extraction, chromatography, filtration, nanofiltration, membrane filtration, using adsorption and/or absorption materials, pH control and precipitation, and combinations thereof. The water treatment technique may include introducing the extracted solution to an ion exchange column, solvent extraction (e.g., biphasic solvent extraction), or both.

The nickel component may be selectively removed from one or more components of the extracted solution, the extraction mixture or both. As a non-limiting example, the nickel component may be removed (e.g., via electrowinning or other extraction methods) and recovered for further processing of the enriched solid nickel concentrate. In a non-limiting example, the extracted nickel component may be added to the enriched solid nickel material that has been upgraded. Advantageously, one or more embodiment methods may allow for a reduced or minimal loss of nickel from a nickel ore material even if relatively low amounts of leach into the extracted solution.

In some embodiments, separating the biobroth or one or more components of the biobroth includes extracting the biobroth or one or more components of the biobroth from the extraction mixture, the extracted solution, or both. The extraction may be performed with one or more water treatments techniques selected from a group consisting of centrifugation, feeding the extracted solution and/or the extraction mixture through an ion exchange system, extracting the magnesium component via solvent extraction, chromatography, nanofiltration, filtration, membrane filtration, using adsorption and/or absorption materials, pH control and precipitation, and combinations thereof.

The biobroth or one or more components of the biobroth may be separated from the rest of the extracted solution and/or liquid mixture and may subsequently be used to form a regenerated extraction composition. For example, one or more components of the biobroth or at least a portion of the biobroth (e.g., one or more organic acids) may be separated from the liquid mixture and/or extraction solution by pH control and precipitation, chromatography, ion exchange, or filtration to form an extracted portion. The extracted portion may be recovered as a solid precipitate, in an aqueous solution, or both.

The regenerated extraction composition may be recovered and reused for subsequent extractions. For example, when the extracted one or more components of the biobroth is recovered as a solid precipitate, the precipitate may be redissolved to form the regenerated extraction composition. In some embodiments, the method includes repeating the extracting, such as with the regenerated extraction composition. In some embodiments, the regenerated extraction composition can be modified after recovery and prior to the repeating the extraction to add an organic acid, an inorganic acid or both, dilute the extraction composition, adjust a pH of the extraction composition (e.g., with a pH adjusting agent that does not interfere with the extraction process), or any combination thereof. The regenerated extraction composition may be transported (i.e., introduced) to the extraction zone, such that the regenerated extraction composition is recycled.

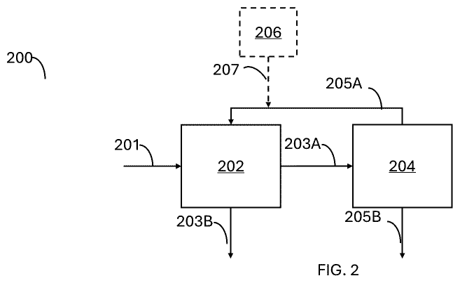

A simplified diagram of a non-limiting extraction process and recycling process may be as shown in FIG. 2. As shown in system 200 of FIG. 2 a nickel-containing ore material, an extraction composition, or both may be introduced to extraction zone 202 via feed line 201. An extracted solution may be introduced to metal atom recovery zone 204 via input line 203A. A treated metal ore material may be recovered from extraction zone 202 via output line 203B. The treated ore material may be analyzed, such as weighed to determine a total mass difference from the untreated ore material. The metal atom recovery zone 204 may include a component to selectively remove nickel, magnesium, iron, cobalt, among other metal atoms (e.g., via line 205B) from the extracted solution such that the extraction composition is regenerated. The system of one or more embodiments may include an organic acid recovery unit (not shown in FIG. 2). The organic acid recovery unit may include components to selectively remove and recover the organic acid (e.g., as a biosolvent) from the extracted solution. In some embodiments, the organic acid recovery unit includes components that are capable of regenerating the extraction composition from the recovered organic acid(s) from the recovered form.

The magnesium component may be separated (or “stripped”) from the extracted solution along with one or more additional metal components (e.g., an iron component, a nickel component, a cobalt component, among others) such that the extraction composition and a mixture of metallic components may be recovered. The magnesium component may be a main component of the mixture of metallic components. In one or more embodiments, each of the magnesium component and, if present, one or more additional metallic components are recovered separately from the extracted solution. In some embodiments, the magnesium component has a purity in a range from 0.5% or greater, 1% or greater, 5% or greater, 10% or greater, 25% or greater, or 50% or greater. The magnesium component may have a purity in a range from 0.1% to 100%. For example, the magnesium component may have a purity in a range having a lower limit of any one of 0.1%, 0.5%, 1%, 2.5%, 5%, 7.5%, 10%, 15%, 20%, 25%, 30%, 35%, 40%, and 50%, and an upper limit of any one of 30%, 35%, 40%, 45%, 50%, 55%, 60%, 65%, 70%, 75%, 80%, 85%, 90%, 95%, 98%, 99%, 99.9%, 99.99%, and 100%, where any lower limit can be paired with any mathematically compatible upper limit.

The regenerated extraction composition may be fed to one or more extraction units of the extraction zone, such as via one or more flow lines (e.g., line 205A) in fluid communication with the metal atom recovery zone 204 and the extraction zone 202. In some embodiments, the regenerated extraction composition is transported to a storage tank to be used in a subsequent extraction process, for example. In some embodiments, it may be determined via analysis of the extraction composition, recovery efficiency of one or more metal atoms, or both, that the regenerated extraction composition requires additional components (e.g., one or more additional components of the extraction composition). The analysis may be performed with a method or system capable of measuring metal atoms in a solid sample (e.g., an ore material), a liquid sample (e.g., an extracted solution, a regenerated extraction composition), or both. Analysis of one or more embodiments may include determination of total mass loss of the untreated ore material, analysis of a sample (e.g., an extracted solution sample) with absorption spectroscopy, fluorescence spectroscopy, high performance liquid chromatography (HPLC), gas chromatography (GC), mass spectrometry (MS), Infrared Spectroscopy (IR), inductively coupled plasma-optical emission spectrometry (ICP-OES) of a solution, X-ray fluorescence of a solid sample, X-ray Diffraction, Modal Mineralogy analysis (e.g., QEMSCAN® analysis), oxidation-reduction potential (ORP), pH, conductivity, or combinations thereof.

A method of one or more embodiments may include providing a measurement system coupled to the extraction system to analyze one or more components of the extraction mixture, such as a regenerated extraction composition. The measurement system may include one or more components configured to perform the analytical methods including, but not limited to ICP-OES, absorption measurement, fluorescence measurements (e.g., excitation and/or emission), HPLC, IR, GC, MS, XRD, XRF, Modal Mineralogy (e.g., QEMSCAN®), ORP, pH, conductivity, among others. The measurement system may include various pumps, flow control components, a control system, among other components. The measurement system may be configured to collect a sample and analyze one or more components of the extraction mixture (e.g., a liquid sample of the extraction mixture) over set time intervals and time periods. In some embodiments, the analysis of a solid sample is performed at an off-site location after separation and collection from an extraction mixture.

In some embodiments, analysis of an extracted sample is carried out after each extraction in the extraction zone. Analysis of a regenerated extraction composition may be performed after processing through the metal atom recovery zone. In some embodiments, the extracted sample, the regenerated extraction solution, or both are continuously measured by one or more components of the extraction system. In some embodiments, the extraction system includes one or more sensors capable of collecting and/or transmitting data to a computer that may be a part of the extraction system or at an off-site location. In some embodiments, one or more parameters (e.g., recycled extraction composition make-up, temperature, pressure, residence time within the extraction zone, etc.) is adjusted based on the data collected from the analytical measurements.

In some embodiments, an extraction composition storage unit 206 can be present in system 200 such that one or more components of the extraction composition may be introduced to the regenerated extraction composition via line 207. In some embodiments, storage unit 206 includes a fermentation broth feed line (not shown) such that unit 206 receives a fermentation broth (e.g., from a fermentation reactor, one or more component configured to modify the broth once obtained from a fermentation reactor, from an external source, etc.) The one or more components may include a filtration unit, centrifugation unit, components capable of forming a cell lysate, or combinations thereof.

In some embodiments, an extraction composition make-up may be introduced to the regenerated extraction composition to regenerate the concentration of the acid(s) in the fermentation broth of the extraction composition, to increase the concentration of the extraction composition relative to the ore material, or to dilute the extraction composition. In such embodiments, the adjusting of the regenerated extraction composition via introduction of the make-up may maintain or increase the extraction efficiency of target metal component(s), enhance the selectivity of target metal component(s), or both.

In another aspect, embodiments herein relate to a method for improving smelting efficiency of an ore material. The method for improving a smelting efficiency may include one or more steps of a method for extracting a metal from a nickel-containing ore material (e.g., as described in method 100 of FIG. 1). The nickel-containing ore material may include a nickel-containing ore and/or a concentrate thereof. The method for improving smelting efficiency may include forming a mixture including an extraction composition and an ore material. The mixture may be as described previously. The method may include selectively removing a magnesium component as described previously from the ore material with reduced removal of an iron component from the ore material, thereby increasing or maintaining the Fe:Mg ratio as compared to conventional extraction compositions.

While the method may include one or more method steps as described above and as shown in FIG. 1, one of ordinary skill in the art will appreciate that some or all of the blocks may be executed in different orders, may be combined or omitted, and some or all of the blocks may be executed in parallel. Furthermore, the blocks may be performed actively or passively. Alternative methods include the use of these combinations of organic acids and conjugate bases to selectively remove gangue from other nickel-containing materials, including, but not limited to, nickel laterite and nickel sulfides. The methods according to the present invention can be used in ore processing applications to remove gangue from ore as part of a leach, separate, regenerate circuit.

The method of one or more embodiments may advantageously upgrade a nickel-containing ore and/or a concentrate thereof as well as or better than traditional processes. The process of one or more embodiments may be cost-effective and can be adapted to equipment currently used in the mining industry. For example, the process of one or more embodiments may be integrated in an existing process and can treat a side stream and/or the whole stream of a nickel-containing ore and/or concentrate thereof. One or more embodiments of the present disclosure may advantageously improve the smelting efficiency of the ore material after extraction as compared to traditional processes. Additionally, the compositions and methods of one or more embodiments unexpectedly alters the selective removal of a magnesium component from a nickel ore material in a way that significantly differs operationally from how a more standard solvent (e.g., the inorganic acid, H2SO4) solubilizes atoms from a nickel ore material. Further, mixtures of certain concentrations of inorganic and organic acids may allow for reduced cost while retaining the advantage of selectively removing magnesium from nickel-containing ore material.

One or more embodiments of the present disclosure are advantageous as multiple organic acids and their conjugate bases obtained from a microbial culture improve selective solubilization of impurities from ore material. In some cases, addition of inorganic acid can further improve the removal of gangue material and impurities. Another advantage demonstrated by the present invention is that using the disclosed process for nickel sulfides reduces the smelting temperature, thereby permitting reduction in the carbon footprint and cost. Furthermore, the one or more embodiments for treating a nickel ore material, such as a nickel sulfide, has a concentration effect in which selectively solubilizing a magnesium oxide impurity can reduce the formation of slag and permit reduction in the carbon footprint and cost. Still another advantage of the present disclosure is that using the disclosed process for a nickel ore material, such as a nickel oxide, exposes more nickel and allows nickel depressants to work more effectively and capture more value from the same amount of material.

### EXAMPLES

The following examples are intended to demonstrate that multiple laboratory experiments were performed to highlight the selectivity for magnesium extraction in accordance with one or more embodiments of the disclosure. These examples are not intended to limit the scope of the present disclosure.

### Example 1

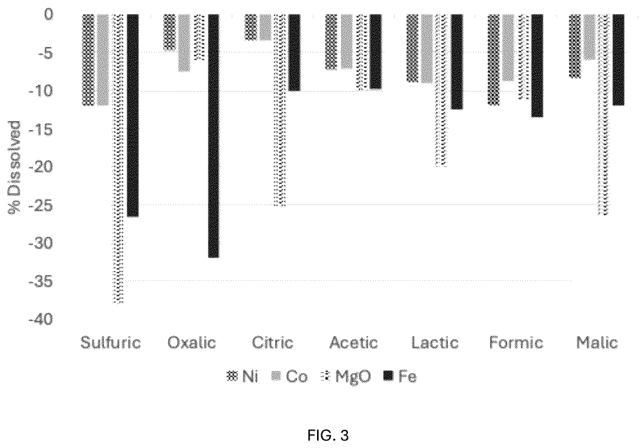

Extraction efficiencies of different acids were performed with different extraction mixtures. For example, sulfuric acid (1 M, 200 mL) and different organic acid solutions each having 1 M total organic acid concentration (200 mL) detailed in FIG. 3. The acids were individually added to different samples of 10 wt % nickel sulfide concentrate (20 grams (g) of nickel sulfide concentrate) for extraction evaluation. Each solution mixture was stirred at 50° C. for 24 hours. After 24 hours, the solid nickel sulfide concentrate was separated from the acidic solution. A percentage of the dissolved element was assessed by combining total mass loss of the solid nickel sulfide concentrate with X-ray fluorescence (XRF) measurements of the isolated solids. Metal atom extraction results for each acid are shown in FIG. 3.

As shown in FIG. 3, citric acid and malic acid each showed the greatest selectivity for magnesium (Mg) solubilization as compared to nickel, iron, and cobalt atoms. Conversely, sulfuric acid demonstrated the highest selectivity for iron relative to the extraction of magnesium, nickel, and cobalt.

### Example 2

Three different biosolvents (i.e., Biosolvents 3-5) were produced by culturing the same Aspergillus species (i.e., Aspergillus niger (ATCC 1015)) in different media. MilliQ water was used as the base solution for Media 2 and 3 to produce Biosolvents 4 and 5, respectively, while tap water was pH adjusted to 5 and used as the base solution for media 1 to produce Biosolvent 3. The media recipes for all media types are based on a standard M9 cultivation media.

In media 1, all salt concentrations (excluding nitrogen and phosphorus salts) are those described in the standard M9 recipe. In media 2 and 3 sodium chloride concentration was reduced to 0.5 g/L. Media 3 differs from media 2 in that it was pH adjusted to 5 prior to autoclaving. Mixes of ATCC trace mineral and vitamin solutions were added to all media at 1 milliliter per liter (mL/L) of media as were magnesium and calcium solutions. Glucose was loaded, after autoclaving, at 75 g/L using a pre-dissolved 50% w/v glucose solution from Teknova.

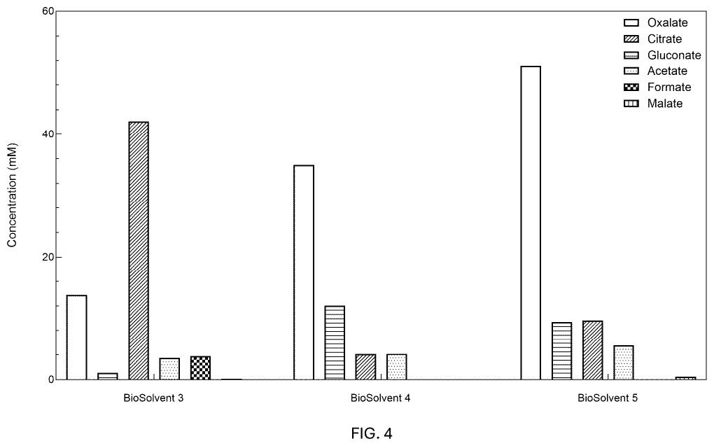

The inoculation process was the same for all media types. Aspergillus spp. preserved in 15% glycerol were thawed aseptically and transferred directly into the growth medium. Cultures were incubated at 25° C., 60% humidity, and 150 RPM (rotations per minute) in baffled polycarbonate flasks for one week before they were harvested. At harvest cultures were first strained through a cheesecloth and then vacuum-filtered through a 0.22 mm polyester sulfone membrane. As shown in FIG. 4, the use of different media can influence the production of different organic acid ratios in unpurified biobroths.

### Example 3

The unpurified biosolvents obtained in Example 2 were used in an ore extraction process for three examples (ore:biobroth ratio 1:10). 4 grams of nickel sulfide concentrate was added to 40 mL of biobroth to create solution mixtures. Each solution mixture was stirred at 70° C. for 24 hours. After 24 hours, the solid nickel sulfide concentrate was separated from the acidic solution. Three additional examples were performed in which hydrochloric acid (HCl) was added to each of Biosolvents 3, 4, and 5 to reduce the pH to 1-2 from a pH of 4-5, and subsequently used to evaluate ore material extraction. Two comparative examples were performed with 1M sulfuric acid and 1M citric acid using the same ore to solvent ratios.

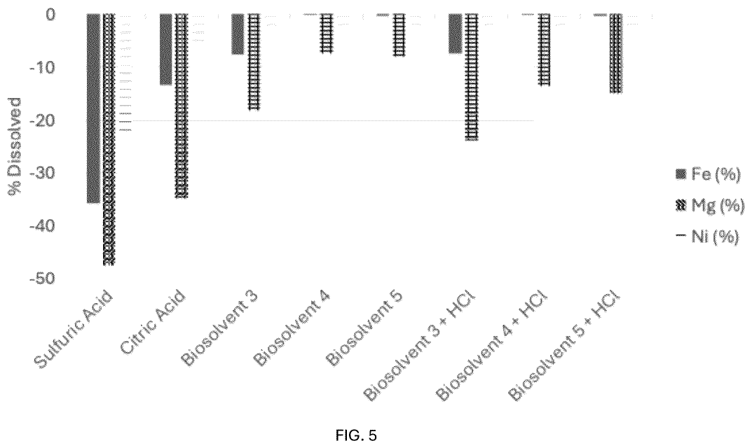

Results are presented in FIG. 5, which shows that biosolvents are selective for the extraction of magnesium component removal from the ore material. Interestingly, Biosolvents 4 and 5 having oxalic acid as a main acid component demonstrated a reverse in selectivity for magnesium and are predominantly selective for iron as shown in FIG. 3. Notably, the results shown in FIG. 5 indicate that there is enhanced selectivity for magnesium removal with unpurified biobroths as compared to an inorganic acid solvent or a citric acid solvent. Additionally, unpurified Biosolvents 4 and 5 with HCl show minimal removal of iron component with an increased percent dissolution of magnesium as compared to extraction processes with only Biosolvents 4 and 5.

### Methods for Examples 4-6: Comparative Extractions

Results for each of Examples 4-6 were obtained by adding 4 grams of nickel sulfide concentrate was added to 40 mL of biobroth or model bio-solvents to create solution mixtures. Model bio-solvents were created by adding purified components of each of the organic acids found in the biobroth mixtures (e.g., as shown in FIG. 4) to MilliQ Water. Each solution mixture was stirred at 70° C. for 24 hours. After 24 hours, the solid nickel sulfide concentrate was separated from the acidic solution.

### Example 4: Results

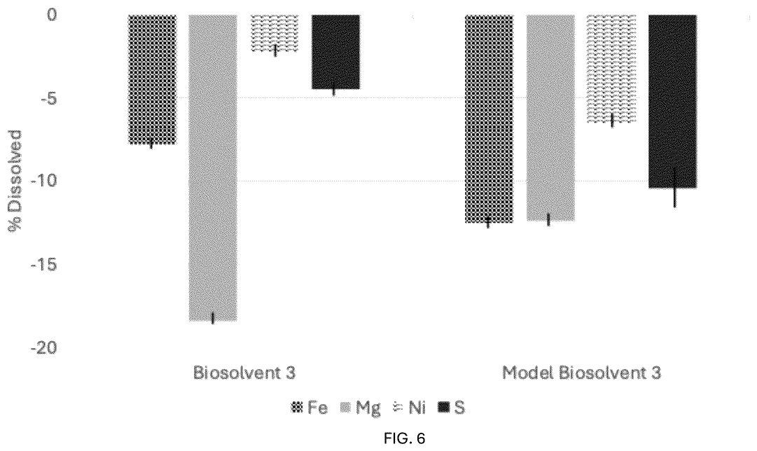

Comparative experiments were performed to determine whether a synergetic effect of Biosolvent 3 (produced as described in Example 2) is observed as compared to the model solvent. Results are shown in FIG. 6, which indicate that the unpurified Biosolvent 3 is advantageously and unexpectedly more selective for magnesium as compared to other components. Thus, Biosolvent 3 displays a synergetic effect as compared to a synthetic mixture of Model Biosolvent 3.

### Example 5: Results

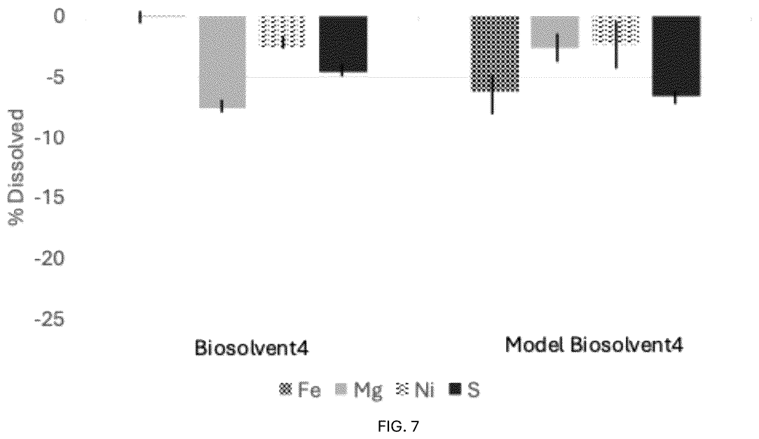

Comparative experiments were performed to determine whether a synergetic effect of Biosolvent 4 (produced as described in Example 2) is observed as compared to the model solvent. Results are shown in FIG. 7, which indicate that the unpurified Biosolvent 4 is advantageously and unexpectedly more selective for magnesium as compared to other components. In contrast, a synthetic mixture of organic acid components displays higher selectivity for the removal of iron and sulfur. Thus, Biosolvent 4, an unpurified fermentation broth, displays a synergetic effect as compared to a synthetic mixture of Model Biosolvent 4.

### Example 6: Results

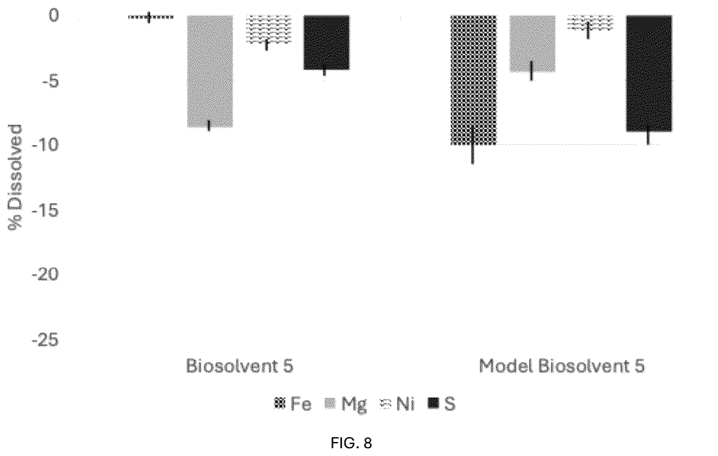

Comparative experiments were performed to determine whether a synergetic effect of Biosolvent 5 (produced as described in Example 2) is observed as compared to the model solvent. Results are shown in FIG. 8, which indicate that there is a reversal in selectivity of unpurified Biosolvent 5 that is advantageously and unexpectedly more selective for magnesium as compared to other components with minimal removal of iron. In contrast, a synthetic mixture of organic acid components displays higher selectivity for the removal of iron and sulfur. Thus, Biosolvent 5, an unpurified fermentation broth, displays a synergetic effect as compared to a synthetic mixture of Model Biosolvent 5.

### Example 7

Recycling of an extraction composition was evaluated with an ion exchange column using an AmberLiteTM IRC120 H Ion Exchange Resin. In particular, an extraction process (or “leaching”) was performed on a 10 wt % nickel sulfide concentrate (20 g of solid) at 70° C. for 24 hours with a citric acid (1 M, 200 mL).

After 24 hours, any remaining solids were separated from the extracted solution. The extracted solution was passed through an ion exchange column to remove the metal component (i.e., cations of iron, magnesium, and nickel) and regenerate the extraction composition. The regenerated extraction composition was used to treat a fresh nickel sulfide concentrate (10 wt % solid suspension in water).

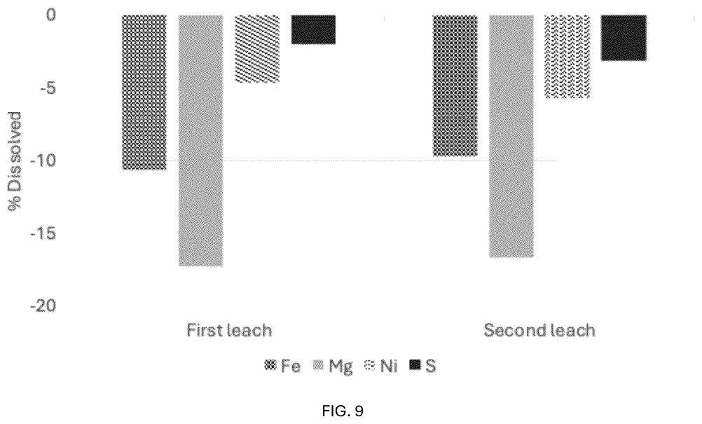

The percentage of dissolved elements in the extracted solution was determined after the first extraction and the second extraction, and results are shown in FIG. 9. For example, the percentage of dissolved element was assessed by combining total volume loss of the liquid extraction composition and ICP-OES measurements of the extracted solution. Data shown in FIG. 9 indicates that there is no loss in selectivity for removal of magnesium from a nickel sulfide concentrate as compared to removal of iron, nickel and sulfur after recycling of the extraction composition.

Recycling of an extraction composition was evaluated via solvent extraction of a model leachate solution having 5 g/L (grams per Liter) of iron (from FeCl2), 5 g/L of magnesium (from MgCl₂), and 1 g/L nickel (from NiCl₂) dissolved in 1 M citric acid solution with pH adusted to 3.5.

### Example 8

The model extraction composition solution was mixed with an organic solvent phase. The organic solvent phase included 40% of di(2-ethylhexyl)phosphoric acid (DEHPA) in kerosene and 55% saponified sodium hydroxide (NaOH). The solvents were shaken for 3 minutes and allowed to settle. The separation of aqueous and organic phases was observed. Samples were taken from the organic and aqueous phases for analysis and compared to the initial aqueous phase samples (i.e., the model leachate solution).

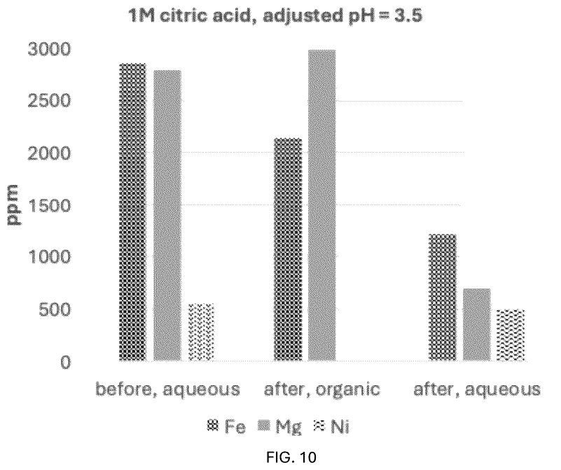

Concentrations of metal ions in the extracted solution are presented in FIG. 10. In particular, there is substantial reduction of iron and magnesium ions in the aqueous phase after biphasic extraction with an organic solvent as compared to the extracted solution prior to biphasic treatment. This indicates that an extraction composition may be regenerated and recycled through the use of biphasic solvent extraction as a relatively large portion of magnesium and iron components can be separated into the organic solvent phase.

### Example 9

A solvent exchange procedure was followed to evaluate the solvent promoted regeneration of an extracted solution including Ni, Fe, and Mg. The study was performed using 40 vol % (volume percent) DEHPA in a kerosene diluent and adding an extracted solution (including 1 M citric acid). The extracted solution had the properties shown in Table 1, below, which include pH, oxidation-reduction potential (ORP), and Fe, Mg, and Ni content in grams per liter (gpl).

TABLE 1
Extracted Solution Properties

| | ORP | Fe | Mg | Ni |
|---|---|---|---|---|
| pH | (mV) | (gpl) | (gpl) | (gpl) |
| 1.01 | 258.6 | 11.9 | 11.2 | 1.9 |

Three extraction shake-out tests were completed by adding the extracted solution (100 mL) and 40 vol % DEHPA (200 mL) to a 500 mL separatory funnel. For the first test, the phases were mixed for 5 minutes, then allowed to separate and the aqueous solution was analyzed for pH, ORP, and metal concentration.

Subsequent tests were carried out in the same manner with the exception of caustic sodium hydroxide addition (NaOH) to increase the pH. For example, in Test 2, 19.5 mL of 10 M caustic was added to the separatory funnel containing the extracted solution and DEHPA solution, and then mixed for 5 minutes. After mixing, the phases were allowed to separate and the aqueous solution was analyzed for pH, ORP and metal concentration. In Test 3, 33 mL of 10 M caustic was added and mixed for 5 minutes, separated, and analyzed.

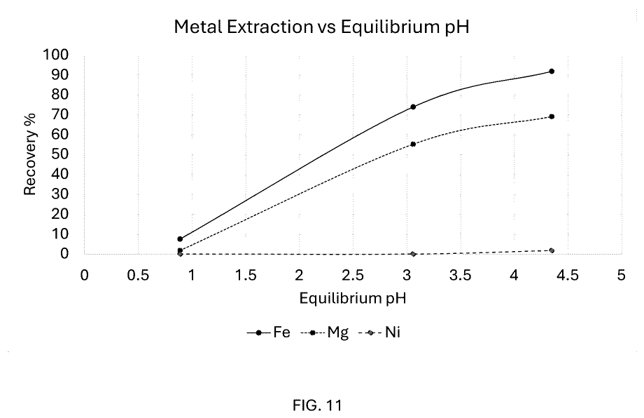

The metal recovery verses equilibrium pH are shown in FIG. 11. As shown in FIG. 11, Fe and Mg extraction from the aqueous phase was achieved with pH modulation during a solvent exchange and with each shake test. In particular, Fe recovery achieved greater than 90% recovery, and magnesium achieved about 70% recovery.

To ensure the biosolvent in the extracted solution was not transferred to the organic phase (i.e., the DEHPA+Diluent), the active components of the aqueous phase (i.e., the citric acid) were analyzed in the starting solution and after each shake-out test. The biosolvent concentration (e.g., the organic acid concentration in millimoles, mmol) was back calculated to adjust for dilution during caustic addition. Results are shown in Table 2 below, which indicate that the organic acid biosolvent does not transfer to the organic phase during contact with DEHPA.

TABLE 2
Active Component Concentration in the Biosolvent

| Starting | Test 1 | Test 2 | Test 3 |
|---|---|---|---|
| 900 | 961 | 1027 | 943 |

### Example 10

A metal extraction with DEHPA using multiple extractions was conducted using 40 vol % DEHPA in diluent (i.e., kerosene) and an extracted solution containing significantly less metals in solution than those present in previously described examples. Metal concentrations and pH are shown in Table 3, below.

TABLE 3
Extracted Solution pH and Metal Concentration

| | Fe | Mg | Ni |
|---|---|---|---|
| pH | (gpl) | (gpl) | (gpl) |
| 1.1 | 0.856 | 0.714 | 0.146 |

Extraction shake-out tests were completed by adding the extracted solution (70 mL) and 40 vol % DEHPA (140 mL) to a 500 ml separatory funnel. A 10 M sodium hydroxide solution was added (23 mL) to the separatory funnel and the phases were mixed for 5 minutes, The phases were allowed to separate, and the aqueous pH and metal concentrations were measured. The aqueous phase (or “raffinate”) was collected from the first shake-out test and contacted a second time with fresh DEHPA (140 ml) in the separatory funnel; 9 mL of 10 M sodium hydroxide was added and mixed for 5 minutes, and the phases were then allowed to separate. The aqueous pH and metal concentrations were analyzed for each aqueous phase collected. The results of the extractions are shown in Table 4, below.

TABLE 4
Extraction Results of Aqueous Phases

| | Equilibrium | | | |
|---|---|---|---|---|
| Samples | pH | Fe (gal) | Mg (gpl) | Ni (gpl) |
| DEHPA Contact 1 | 4.22 | 0.021 | 0.314 | 0.145 |
| DEHPA Contact 2 | 4.37 | 0.007 | 0.068 | 0.166 |

As a result of the lower metal concentrations in the extracted solution and the second contact with fresh DEHPA, the metal extraction of Fe and Mg were significantly improved, while Ni was not extracted. The overall recovery of Fe and Mg after the two contacts were 99.2% and 90.4%, respectively.

### Example 11

Testing was performed to investigate the use of calcium chloride (CaCl₂) to precipitate citric acid as calcium citrate with the use of sodium hydroxide for pH adjustment. Sodium hydroxide was used for pH adjustment as sodium citrate solubility in water is greater than calcium citrate. Slacked calcium oxide/calcium hydroxide was not used specifically to prevent the possibility of localized precipitation of metals or citric acid on the solid particle surface and to improve kinetics as the solids are only modestly soluble in water. An extracted solution having the pH and metal concentrations shown in Table 5, below, was used for testing.

TABLE 5
Extracted Solution pH and Metal Concentrations

| | Fe | Mg | Ni |
|---|---|---|---|
| pH | (gpl) | (gpl) | (gpl) |
| 1.01 | 0.856 | 0.714 | 0.146 |

Testing was performed using a 250 mL beaker and stir bar on a magnetic stir plate at room temperature. The extracted solution (50 mL) was added to the beaker and stirred, 0.1 M CaCl₂ was added, and 10 M sodium hydroxide was added incrementally to increase the pH. After each sodium hydroxide addition, the solution was allowed to mix for 15 minutes, and the pH was measured. Samples were taken at pH 5.6 and 8.4 and analyzed for metal and citric acid concentration. Table 6, below, includes the measured concentration results.

TABLE 6
Measured pH and Concentration of Samples

| | | | | | | Citric |
|---|---|---|---|---|---|---|
| | | Fe | Mg | Ni | Ca | acid |
| Samples | pH | (gpl) | (gpl) | (gpl) | (gpl) | (mmol) |
| Starting (extracted) | 1.1 | 0.856 | 0.714 | 0.146 | 0.005 | 1005 |
| solution | | | | | | |
| Sample 1 | 5.62 | 0.874 | 0.720 | 0.134 | 0.047 | 1020 |
| Sample 2 | 8.41 | 0.789 | 0.637 | 0.118 | 0.180 | 683 |

The results in Table 6 show that the citric acid concentration did not decrease at pH 5.6 but decreased at pH 8.4, with minimal drop in metal concentrations. Although not optimized, for calcium concentration, kinetics, temperature, pH, etc., the measured concentrations of the different samples indicate that the precipitation of citric acid could be a viable means of selectively precipitating and separating calcium citrate from metal ions to regenerate the biosolvent for subsequent extractions. For example, one can envision that addition of an acid, such as sulfuric acid addition, would be required to convert the calcium citrate to citric acid by precipitation of calcium sulfate to redissolve the citric acid in an aqueous solution.

### Example 12

The extracted solution of two different nickel sulfide concentrates from sites across the globe were compared. 10 wt % of each nickel sulfide concentrate sample (20 g of solid) was introduced to an extraction composition having 1 M citric acid solution (200 mL). Each of the two samples were stirred for 24 hours at 70° C. After 24 hours, the solid nickel sulfide concentrate was separated from the acidic solution. The percentages of the dissolved metal atoms were assessed by combining a total volume loss with ICP-OES measurements of the extracted liquid solution after separation from solids.

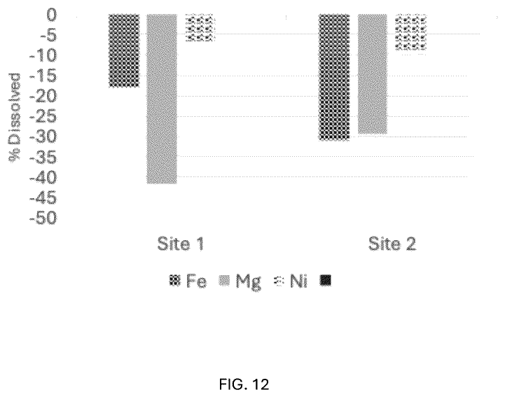

Selectivity for magnesium solubilization as compared to nickel and iron solubilization is shown in FIG. 12. As shown in FIG. 12, the extraction composition favors selectivity for the removal of magnesium and iron as compared to the extraction of nickel from the nickel sulfide concentrates.

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It is to be understood that the singular forms “a,” “an,” and “the” include plural referents unless the context clearly dictates otherwise. Thus, for example, reference to “a horizontal beam” includes reference to one or more of such beams. Also, for example, reference to a combination containing “a conjugate base” includes a mixture of two or more conjugate bases, reference to “an organic acid” includes reference to one or more of such organic acids, and reference to “an ionic liquid” includes reference to a mixture of two or more ionic liquids.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to distinguish such disclosure from the presently described invention.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

It is to be understood that one or more of the steps shown in the flowcharts may be omitted, repeated, or performed in a different order than shown. Accordingly, the scope disclosed should not be considered limited to the specific arrangement of steps shown in the flowcharts.

Unless defined otherwise, all technical and scientific terms used herein have the same meanings as commonly understood by one of ordinary skill in the art to which this invention belongs.

Although multiple dependent claims are not introduced, it would be apparent to one of ordinary skill that the subject matter of the dependent claims of one or more embodiments may be combined with other dependent claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A mixture, comprising:
a nickel-containing ore and/or concentrate thereof; and
an extraction composition comprising:
a fermentation broth obtained from a natural and/or engineered organic acid-producing microbe,
wherein the extraction composition is configured to selectively solubilize one or more components comprising a magnesium component, wherein the magnesium component comprises one or more magnesium minerals, a magnesium salt, or any combination thereof from the nickel-containing ore and/or concentrate thereof.

2. The mixture of claim 1, wherein the mixture is configured to extract the magnesium component, wherein an extracted magnesium component has a purity in a range from 1% to 80%.

3. The mixture of claim 1, wherein the mixture is configured to produce a treated nickel-containing ore and/or concentrate thereof having an iron component content in a range from 0 wt % to 85 wt % less than an untreated nickel-containing ore and/or concentrate thereof.

4. The mixture of claim 1, wherein the mixture is configured to produce a treated nickel-containing ore and/or concentrate thereof having a magnesium component content in a range from 10 to 80 wt % less than an untreated nickel-containing ore and/or concentrate thereof.

5. The mixture of claim 1, wherein the nickel-containing ore and/or concentrate thereof comprises nickel sulfide, a lateritic nickel compound, or any combination thereof.

6. The mixture of claim 1, wherein the fermentation broth comprises:
a mixture of organic acids comprising an acid selected from the group consisting of oxalic acid, citric acid, gluconic acid, acetic acid, malic acid, formic acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof; and
optionally, an inorganic acid selected from the group consisting of sulfuric acid, hydrochloric acid, nitric acid, and combinations thereof,

7. The mixture of claim 6, wherein a concentration ratio of a first organic acid to an additional acid is in a range from 1:0 to 1:≤1.

8. A method for improving a smelting efficiency of a nickel-containing ore and/or a concentrate thereof, the method comprising:
forming the mixture of claim 1; and
separating a treated nickel-containing ore and/or concentrate thereof from the mixture of claim 1, wherein the treated nickel-containing ore and/or concentrate thereof comprises:
a reduced iron component content in a range from 0 wt % to 85 wt % less than an untreated nickel-containing ore and/or concentrate thereof, and
a reduced magnesium component content in a range from 10 to 80 wt % less than the untreated nickel-containing ore and/or concentrate thereof.

9. A method for extracting a metal from a nickel-containing ore and/or concentrate, the method comprising:
selectively solubilizing a magnesium component comprising one or more magnesium minerals, a magnesium salt, or any combination thereof from the nickel-containing ore and/or concentrate thereof into an extraction composition comprising a broth obtained from fermentation of a natural and/or engineered organic acid-producing microbe.

10. The method of claim 9, wherein, after treatment, the nickel-containing ore and/or concentrate thereof comprises a reduced iron component content of 0 to 60 wt % less than an untreated nickel-containing ore and/or concentrate thereof, and a reduced magnesium component content of 10 to 80 wt % less than the untreated nickel-containing ore and/or concentrate thereof.

11. The method of claim 9, wherein selectively solubilizing comprises:
introducing the broth obtained from the natural and/or engineered microbe to an extraction zone, the broth comprising a mixture of organic acids comprising an acid selected from the group consisting of oxalic acid, citric acid, gluconic acid, acetic acid, malic acid, formic acid, and combinations thereof;
introducing the nickel-containing ore and/or concentrate thereof to the extraction zone;
forming an extraction mixture with the broth and the nickel-containing ore and/or concentrate;
agitating the extraction mixture in the extraction zone to form a liquid mixture comprising the broth and the magnesium component, and, optionally, one or more additional components extracted from the nickel-containing ore and/or concentrate thereof; and
separating the liquid mixture from the nickel-containing ore and/or concentrate thereof.

12. The method of claim 11, further comprising:
separating the magnesium component and, if present, the one or more additional components from the liquid mixture; and
recovering the extraction composition to produce a recovered extraction composition,
wherein the separated magnesium component has a purity in a range from 10 to 100%.

13. The method of claim 11, further comprising:
introducing a recovered extraction composition to the extraction zone, thereby recycling the recovered extraction composition.

14. The method of claim 11, further comprising:
adjusting a temperature of the extraction zone to a temperature in a range from 20 to 100° C., wherein the mixture is in the extraction zone for a period of time in a range from 1 to 24 hours.

15. The method of claim 11, further comprising adding an inorganic acid selected from the group consisting of sulfuric acid, hydrochloric acid, nitric acid, phosphoric acid and combinations thereof to the broth.

16. A method for extracting a metal from nickel sulfide ore, the method comprising:
extracting a magnesium component comprising one or more magnesium minerals, a magnesium salt, or any combination thereof from a nickel-containing ore and/or concentrate thereof into an extraction composition comprising a broth obtained from a culture of a natural and/or engineered microbe;
separating the nickel-containing ore and/or concentrate thereof from an extracted magnesium component and broth;
separating the broth from the extracted magnesium component; and
repeating the extracting,
wherein the extracted magnesium component has a purity in a range from 10% to 90%.

17. The method of claim 16, wherein separating the extracted magnesium component from the broth comprises:
treating the extracted magnesium component and the broth with one or more water treatment techniques.

18. The method of claim 17, wherein treating the extracted magnesium component and the broth with the one or more water treatment techniques comprises performing one or more water treatment techniques selected from the group consisting of feeding the broth through an ion exchange system, extracting the magnesium component via solvent extraction, chromatography, filtration, nanofiltration, membrane filtration, reverse osmosis, using adsorption and/or absorption materials, pH control and precipitation, or any combination thereof.

19. The method of claim 18, wherein performing the one or more water treatment techniques further comprises:
separating one or more additional components from the broth; and
recovering the one or more additional components,
wherein the one or more additional components comprise Ni, Fe, Co, or any combination thereof.

20. The method of claim 16, wherein the separated nickel-containing ore and/or concentrate thereof comprises:
a reduced iron component content in a range from 0 wt % to 85 wt % less than an untreated nickel-containing ore and/or concentrate thereof, and
a reduced magnesium component content in a range from 10 to 80 wt % less than the untreated nickel-containing ore and/or concentrate thereof.
